(19) United States
(12) Patent Application Publication
(10) Pub. No.: US 2013/0129994 A1
(43) Pub. Date: May 23, 2013

(54) Forming A Pigment Pattern On A Substrate

(71) Applicant: Robert L. Wells, JR., Thetford Center, VT (US)

(72) Inventor: Robert L. Wells, JR., Thetford Center, VT (US)

(73) Assignee: FUJIFILM DIMATIX, INC., Lebanon, NH (US)

(21) Appl. No.: 13/300,096

(22) Filed: Nov. 18, 2011

(51) Int. Cl. B05D 1/28; B05D 1/34; B32B 5/16; B05C 1/02; B05C 19/00; B05D 1/12; B05D 3/00

(52) U.S. Cl. 428/207; 427/197; 427/196; 118/211

(57) ABSTRACT

Among other things, a pattern of dry particles of a pigment is provided on a transfer layer. The pattern of dry particles is transferred onto a surface of a ceramic substrate in preparation for firing of the dry particles to form a permanent pattern on the ceramic substrate.

This application incorporates U.S. application Ser. No. 13/086,077, filed Apr. 13, 2011, by reference in its entirety.

### BACKGROUND

This description relates to forming a pigment pattern on a substrate.

### SUMMARY

The forming of a pigment pattern on a substrate that we describe here may be characterized by one or more of the following aspects, features, and implementations, and others.

In general, in an aspect, a pattern of dry particles of a pigment are provided on a tacky surface on a transfer layer, and the pattern of the dry particles is transferred onto a surface of a ceramic substrate in preparation for firing the dry particles to form a permanent pattern on the ceramic substrate.

Implementations may include one or more of the following features. Providing the pattern of dry particles of a pigment on a tacky surface includes forming a pattern of tacky material on the surface. Forming a pattern of tacky material on the surface includes jetting a material. Providing a pattern of dry particles of a pigment on a tacky surface includes applying dry particles of the pigment to a pattern of tacky material on the surface. Transferring the pattern of the dry particles onto the surface of the ceramic substrate includes bringing the pattern into close proximity to or in contact with the ceramic substrate. The ceramic substrate has a temperature above the ambient temperature when the pattern is in close proximity to or in contact with the ceramic substrate. The ceramic substrate is at a temperature between 80° C. and 120° C. A second pattern of dry particles of a second pigment is provided on a tacky material on the transfer layer. The pattern of dry particles is frozen before providing the second pattern of dry particles of a second pigment. A movement of the ceramic substrate is coordinated to a movement of the transfer layer to achieve accurate registration. A movement of the ceramic substrate is coordinated to the movement of the transfer to achieve accurate registration of the pattern and the second pattern on the substrate. The pattern includes multiple identical patterns on the transfer layer. A spacing between the multiple identical patterns on the transfer layer is controlled to match a spacing between a plurality of ceramic substrates onto which the identical patterns are to be transferred. The pattern includes multiple unique patterns on the transfer layer. A spacing between multiple unique patterns on the transfer layer is controlled to match a spacing between a plurality of ceramic substrates onto which the multiple unique patterns are to be transferred. The transferring of the pattern of dry particles includes heating the pattern of dry particles to release the pattern from the transfer layer. The tacky material includes wax. The ceramic substrate is not heated during the transferring of the pattern. A pattern of dry particles of a second pigment is provided on a tacky surface on a second transfer layer. The transfer layer and the second transfer layer are separated by a distance along the width of the transfer layer on the order of the width of the transfer layer. The dry particles have a diameter of between 8 and 20 microns. The dry particles have a diameter of between 5 and 8 microns. The dry particles have a diameter of between 0.5 to 5 microns.

In general, in an aspect, a pattern of dry particles of a pigment is provided on a tacky surface on a transfer layer, and the pattern of the dry particles is transferred onto a surface of a rigid substrate in preparation for processing the dry particles to form a permanent pattern on the rigid substrate.

Implementations may include one or more of the following features. The rigid substrate includes at least one of stone tiles, slate tiles, metal tiles and ceramic tiles. Providing the pattern of dry particles of a pigment on a tacky surface includes forming a pattern of tacky material on the surface. Forming a pattern of tacky material on the surface includes jetting a material. Providing a pattern of dry particles of a pigment on a tacky surface includes applying dry particles of the pigment to a pattern of tacky material on the surface. Transferring the pattern of the dry particles onto the surface of the rigid substrate includes bringing the pattern into close proximity to or in contact with the rigid substrate. A second pattern of dry particles of a second pigment is provided on a tacky material on the transfer layer. A movement of the rigid substrate is coordinated to a movement of the transfer layer to achieve accurate registration. A movement of the rigid substrate is coordinated to the movement of the transfer to achieve accurate registration of the pattern and the second pattern on the substrate. The transferring of the pattern of dry particles includes heating the pattern of dry particles to release the pattern from the transfer layer. The tacky material includes wax. A pattern of dry particles of a second pigment is provided on a tacky surface on a second transfer layer. The transfer layer and the second transfer layer are separated by a distance along the width of the transfer layer on the order of the width of the transfer layer. In general, in an aspect, a transfer apparatus includes a first surface to temporarily hold a pattern of dry particles of pigments, a second surface to support a substrate onto which the pattern of dry particles of pigment is transferred; and a conveyor to move the first surface relative to the second surface to cause the pattern of dry particles of pigments to be transferred onto the substrate.

Implementations may include one or more of the following features. The conveyor coordinates a movement of second surface to a movement of the first surface to achieve registration. A heater to heat the pattern of dry particles to release the pattern from the first surface. A third surface to hold a pattern of dry particles of a second pigment. The first surface and the third surface are separated by a distance along the width of the first surface on the order of the width of the first surface.

In general, in an aspect, a printing system, includes such a transfer apparatus, an inkjet head to jet a pattern of tacky material onto the first surface; an applicator to deposit dry particles of pigments onto the pattern of the tacky material to form a pattern of dry particles of pigments corresponding to the pattern of tacky material; a kiln to fire the pattern of dry particles of pigments permanently onto the substrate; and a conveyor to relay the substrate bearing the dry particles of pigments to the kiln for firing.

In general, in an aspect, a processing line includes such a printing system in which the substrate includes hot green tiles, and the printing system is to receive the plurality of hot green tiles on the second surface.

In general, in an aspect, an article comprises a ceramic substrate bearing a jetted pattern of at least one of wax, glue, epoxy, and adhesive, and dry particles of pigments held by the jetted pattern.

These and other features and aspects, and combinations of them, can be expressed as systems, components, apparatus, methods, means or steps for performing functions, methods of doing business, and in other ways.

Other features, aspects, implementations, and advantages will be apparent from the description and the claims.

### DESCRIPTION

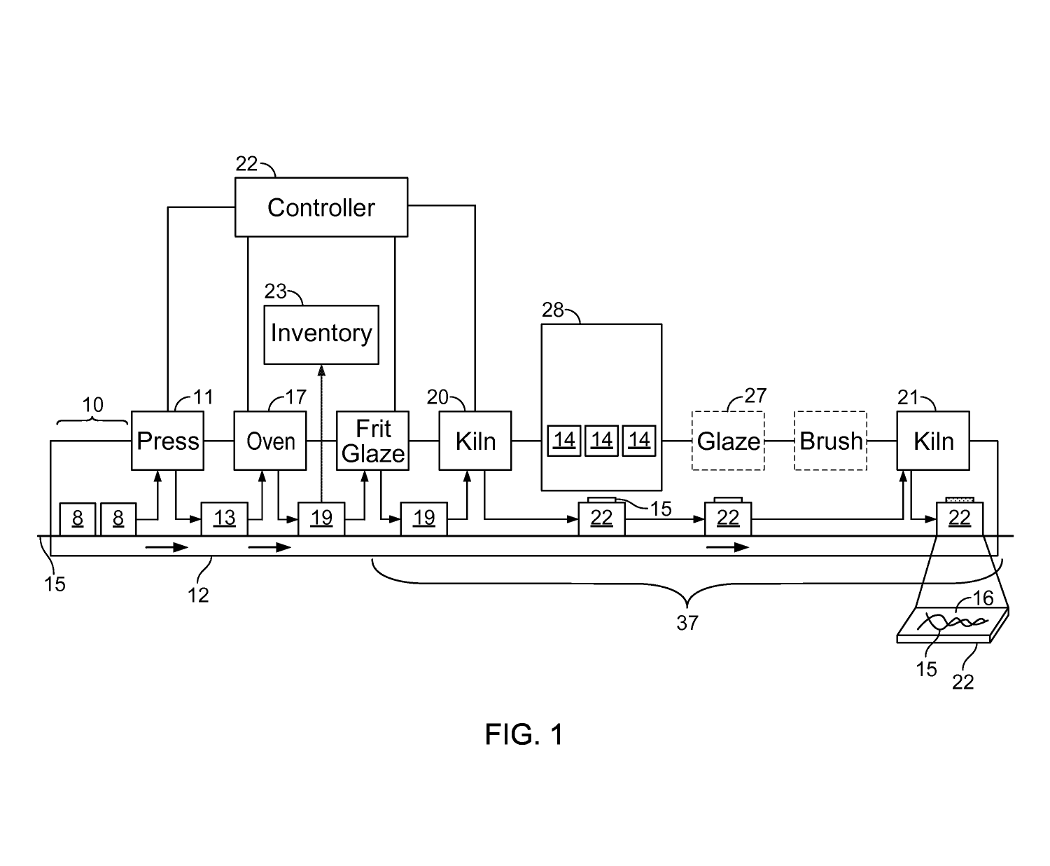

FIG. 1 is a schematic view of a processing line.

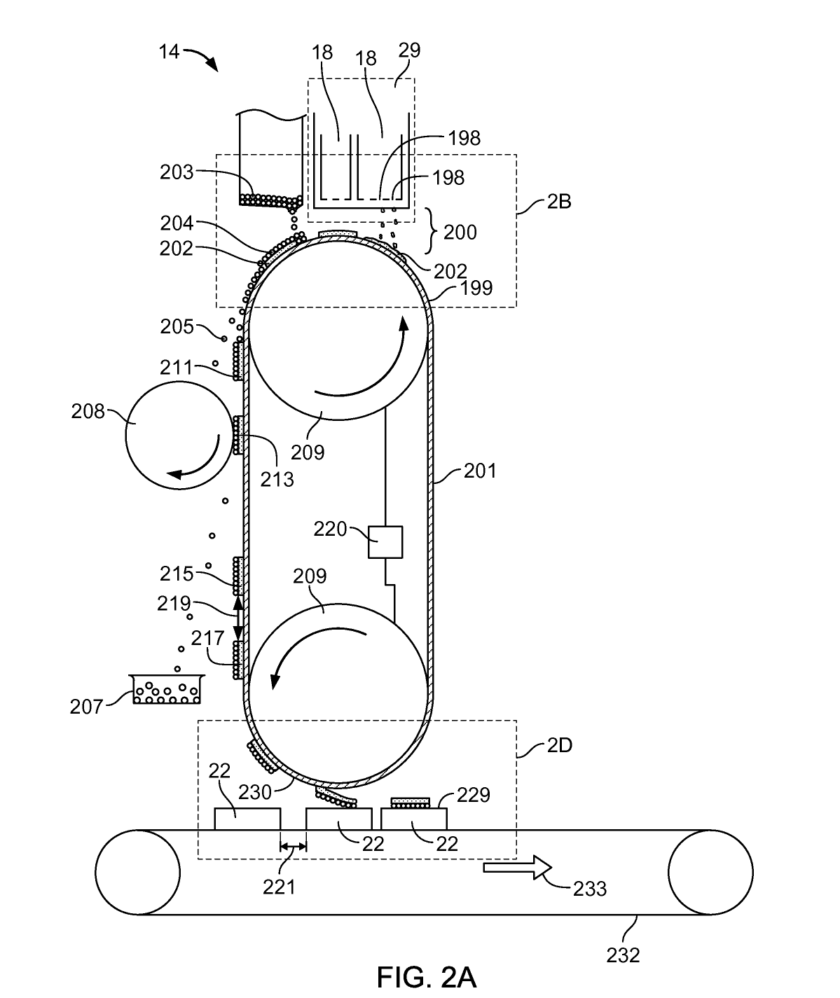

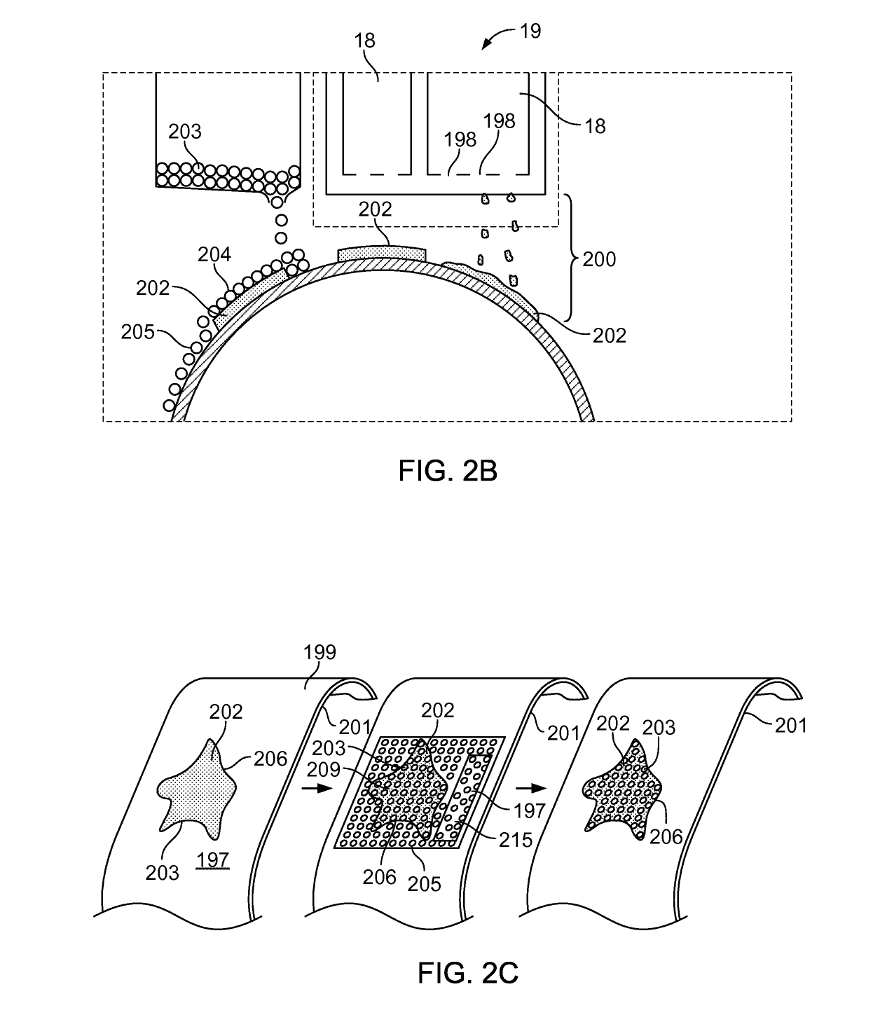

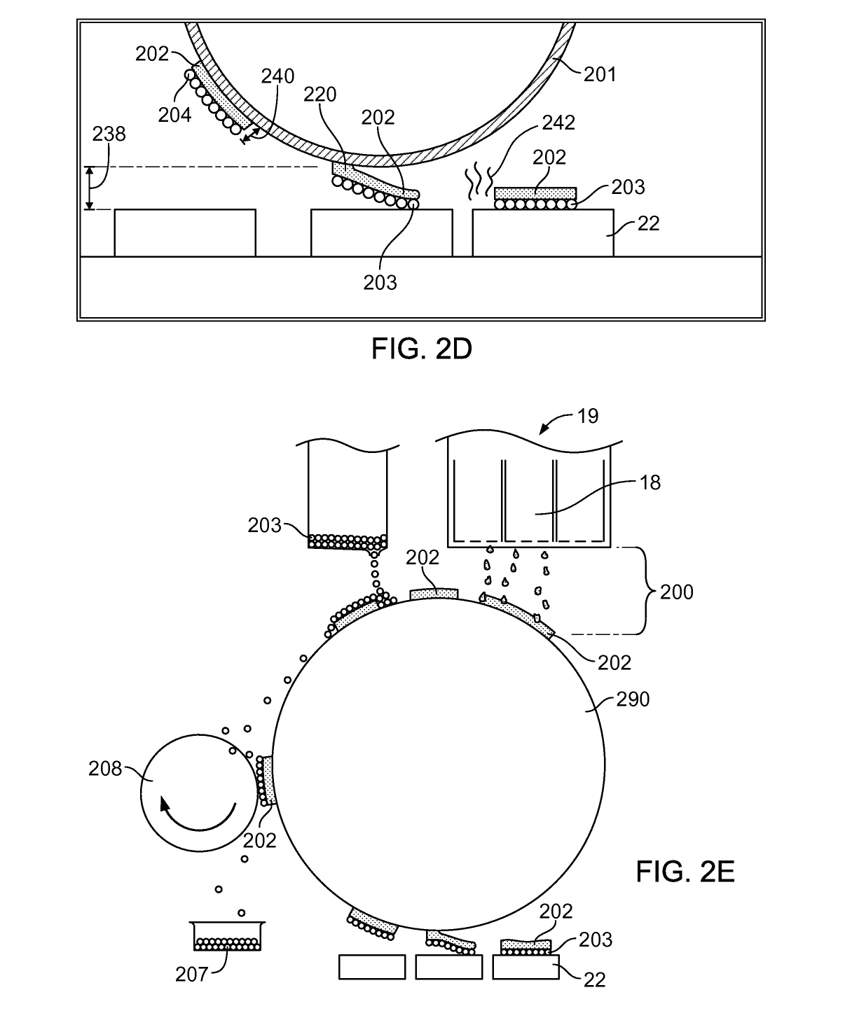

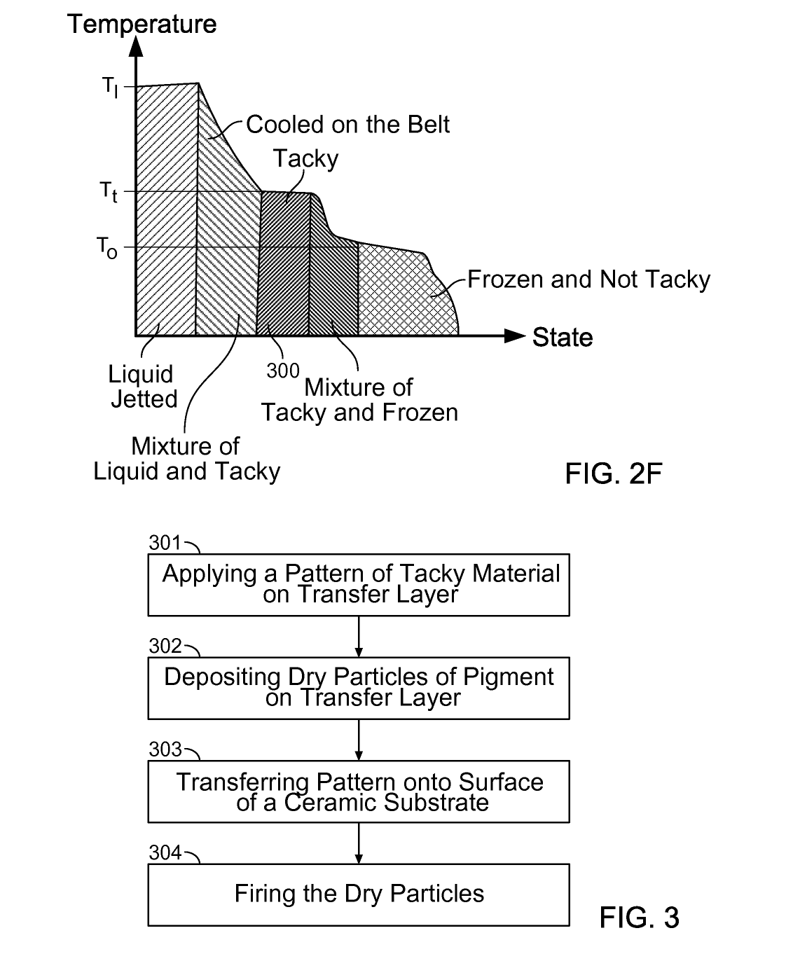

FIGS. 2A, 2B, 2D, 2E, 4A, 4B, 4C and 5 are schematic sectional side views of portions of a pigment transfer station.

FIG. 2C is a schematic view of a belt at successive stages.

FIG. 2F is a schematic plot of the states of a tacky material.

FIG. 3 is a flow chart.

In our discussion, we use the term jetting broadly to include, for example, any forcing of fluid from an orifice and onto a target, including drop-on-demand systems. We mean to include, but not be limited to, a wide variety of ink jetting systems and the inkjet heads that are part of them, including those that now exist and may be developed in the future, for jetting onto any kind of target.

When we use the term tacky, we include broadly, for example, any property of a material or surface that enables the material or surface to retain substantially dry particles when they are put into contact with it, such as particles (of any size, but including large particles) of dry pigments. Particles are substantially dry if, for example, they would not themselves be able to be retained on a non-tacky surface when under the influence of an external force.

When we use the term tacky material, we are referring to any kind of material that is in a tacky state. Tacky materials may sometimes be tacky and at other times not tacky. For such a material, other properties of the material, such as its general nature, its temperature, its wetness, the passage of time, its chemical state, and a wide variety of other properties can determine whether it is tacky at a particular time. Tacky materials can include, for example, traditional and non-traditional waxes when they are in a non-solid state. Tacky materials also encompass latex and glue. In general, tacky materials can include, for example, any adhesive, epoxy, gum, polymer, rubber, paint (in any form that includes a solvent), and varnish (paint without pigment). Examples of glues include: collagen-based animal glue, plant-based glues, solvent-type glues, and synthetic monomer and polymer glues.

When we use the term phase change material, we mean broadly to include, for example, any material that undergoes a reversible phase change from solid to liquid at a temperature that is in the range of, for example, 40° C.-200° C. Phase change materials can include, for example, traditional or non-traditional wax and any artificial or natural wax and also any other material (whether or not called a wax) that undergoes such a reversible phase change. Materials that undergo phase changes at other temperatures and in other temperature ranges may also be included. Phase change materials can be tacky while in one or more of their phases or at times when they are in transition between phases. For example, when a phase change material is in its liquid phase, it may be tacky. It also may be tacky when it is in transition between a liquid phase and a solid phase. Typically, when we refer to a solid phase of a material, we mean a phase that is not tacky. However, in the solid phase, particles that were retained by the material when it was tacky may continue to be entrained in and held by it. When we use the term wax, we include materials that comprise a single wax or any mixture of waxes in any proportions.

We use the term particles broadly to include, any kind of, for example, elements of a material that have a size (for example, diameter or largest dimension) in the range of well under one hundred to hundreds of nanometers (nm). When we refer to large particles, we include broadly, for example, particles in the range of 1 to 1000 μm (between 1 to 20 μm, between 100 to 500 υm, between 500 to 1000 μm). The particles can be round, or irregular, or crystalline, plate like or spherical.

Although the term pigment typically refers to something that imparts color or colors, here we refer to a pigment in a broader sense and we intend to include, broadly, e.g., any kind of material that provides a color or colors or other, for example, visible or tactile or protective or finishing characteristic or quality (including non-color) to a substrate on which the pigment is deposited (and, in some cases, later fired). In some cases, a pigment is referred to as an earth pigment, by which we mean to include a pigment derived from naturally occurring substances, such as rock and other hard materials. As we discuss below, a pigment can provide color to a substrate, but a pigment in our way of using the term could also include particles that provide other characteristics, such as a glaze or frit (in a continuous layer, a large-scale pattern or a small-scale pattern or texture) when applied to a substrate and fired, for example.

We use the term, printed effects, in a broad sense to include, for example, color or colors, or other visible, tactile, protective, or finishing characteristic or quality, whether or not visible, and whether (if visible) opaque, translucent, or transparent, among other things.

A typical graphics pigment (for example, a pigment used in multiple color, often high resolution letterpress, offset, or inkjet printing on paper or textiles) has particles that have diameters that are about 100 nm. Yet, in an ink containing a graphics pigment, the particles can have sizes that range from well under 100 nm to over 1 micron. A ceramic pigment (used for printing, for example, on a ceramic substrate) has particles that, on average, are typically larger. Examples of such ceramic pigments include finely ground ceramic pigments that have particles that are micron-sized.

By the term color, we mean, for example, any color in the visible and non-visible spectrum, and black, white, and gray-scale.

We use the term substrate also broadly to include, for example, any workpiece onto which a pattern or image or text is transferred. Sometimes the work piece is a glass or ceramic tile or other item on which a pattern or image or text is to be laid down and fired. But the work piece could be any kind of material in any form, phase, shape, size, weight, density, or configuration. A ceramic substrate can be any mixture of one or more clays (for example, red clay, white clay, illitic clay, and/or kaolinitic clay) and one or more other materials (for example, sand, talc, feldspar, calcite, dolomite, and/or quartz) that are pressed into a shape and baked or fired at a high temperature.

We use the term fire broadly to include, for example, applying high heat to cause particles to melt and form a mass that, when cooled, forms a hard material, such as permanently on a substrate. In some examples, firing includes the high heating that occurs in a kiln. High heat can include heating to a temperature that is in the range of, e.g., 550-1350° C. For example, kilns for overglaze or china painting can operate at temperatures between 550° C. and 800° C., or between 586 C to 763° C.; kilns for glass firing can operate at temperatures between 750° C. to 950° C., for example between 757° C. to 915° C.; kilns for low fire ceramics can operate at temperature between 950° C. to 1200° C., for example between 981° C. to 1154° C.; kilns for mid fire ceramics can operate between 1100° C. to 1300° C., for example between 1112° C. to 1257° C.; and high fire ceramics can operate at temperature between 1200° C. to 1350° C., for example between 1211° C. to 1305° C. In some examples, the mass is formed from something that might not be called particles and the something from which the mass is formed may not require heating as hot as the temperature range just mentioned.

We use the term freeze to include, for example, cooling a material so that it undergoes a phase change from liquid to solid. The cooling could occur naturally as heat is dissipated into a cooler ambient, or could be caused deliberately by cooling equipment.

In using the term orifice, we broadly include, for example, any opening at the end of a fluid pathway through which fluid is jetted towards a target.

We use the term pattern broadly to include, for example, any image, design, text, graphics, arrangement, or array, or a combination of them, among other things.

In paper printing processes, inks of a small number of different basic colors can be overlaid to create (subtractively) a broad gamut of colors in extremely complex patterns at high resolution. Paper process inks typically are transparent and incident light reflected off the paper, passing through all of the overlaid ink colors on its way to the viewer's eyes. The transparent inks absorb wavelengths of the reflected light according to the colors of those inks. The transparency of paper process inks allows the inks to be overlaid to achieve a large color gamut. In contrast, ceramic pigments are typically (but not always) opaque and the last pigment laid down determines the color that is visible.

Rigid surface substrates include ceramic tiles, metal tiles, stone tiles and slate tiles. In some examples, to print a multicolor pattern on a ceramic tile, the pattern may be divided into regions, each of which will exhibit one of a small number of final colors that are to appear on the finished tile. Typically the final color on the finished tile is not achieved additively by overlaying multiple colors, although some overlaying of colors may be possible.

For printing, the ceramic tile is typically moved along a processing line past a series of printing stations, each of which can lay down a pigment having one of the final colors, in a sub-pattern comprising the regions (which may or may not overlap with regions on which other colors are laid down) where that final color is to appear. The laying down of the successive sub-patterns by the respective printing stations must be carefully registered so that the final fired pattern looks good on the finished tile. The accuracy of the registration may degrade as the distances between successive pairs of printing stations increases.

In typical printing on ceramic tiles, each printing station operates in an analog mode, something like a rotogravure paper-printing station, except that instead of using a plate mounted on a cylindrical drum, a patterned silicone layer is carried on a long belt wrapped around two pulleys. The dry particles of pigment are loaded into the recesses of the patterned layer very close to where the layer wraps around one of the pulleys, which is adjacent to the substrate. The surface of the layer is scraped to remove particles that are on the surface rather than in the recesses. As the belt moves around the pulley, the particles are transferred (dropped) onto the tile. The recesses form a series of deep holes in the belt, which is typically 1/16 to ⅛ inch thick. The diameter of the holes is typically not more than one to two times the thickness of the belt. The aspect ratio of these holes helps to retain dry particles in the belt before the particles are transferred onto the tiles. The belt does not actually touch the tile for the purpose of transfer, unlike in the wet ink case.

Tile manufacturers also sometimes include digital printing stations along such a process line, where inks can be laid down digitally from inkjets onto the tiles. Multiple colors can be laid down by successive digital printing stations with good registration to permit additive broad gamut color printing.

For some colors that are to appear on the finished tile, the pigments must be provided in the form of relatively large particles (e.g., more than 1 micron, more than 5 microns, or more than 8 microns diameter) to exhibit the desired color when fired. This is true, for example, of certain pigments that are based on gold particles and are designed to print a red color on the final tile.

In some printing, pigments are ground into small enough particles to remain in suspension within a liquid or wax-based medium, to form an ink. The ink can be laid down in a pattern on the tile, and then fired. In an analog printing station, for a particular color to be printed on a tile, a rotogravure drum with a silicone outer plate is used. The silicone plate is patterned with recesses or holes. The ink is spread over the layer, a squeegee is used to wipe away the excess ink on the surface, and the ink from the recesses is then transferred by contacting the drum with the tile. In inks having pigments comprised of large particles, the particles can settle easily.

As shown in FIG. 1, in some examples of the concepts that we are describing here, printing is done on discrete precursor workpieces 10 that are formed of a powder mixture 8 that includes,e.g., clay, water, and earth materials. The workpieces, which will eventually become finished ceramic tiles 22, enter a processing line 12 (for example, they may be carried along on a conveyor 15). The precursor workpieces 8 are processed using a press 11 that exerts a pressure of, for example, about 400 pounds per square inches on each of the precursor workpieces 10, to yield a wet green tile 13, which has a 5-10% water content, for example. The wet green tiles 13 may be squares having sides of 700 mm. Along the processing line 12, a drying oven 17 operating at 200° C. receives the wet green tiles 13 and dries them into tiles 19. The tiles 19 may be sent temporarily to an inventory 23 (and later re-entered into the processing line) or sent further along the processing line 12 for decoration or other printing. Decoration can be added either before the first firing or after, and the process of adding decoration and firing can be repeated several times. The more expensive tiles are typically fired four different times or more, and the successive firings do not have to be in line. In some cases, a tile may be fired and decorated one day, cooled and stored to be processed further the next day with additional decoration and firings.

A tile or other workpiece is sometimes said to be “green” before undergoing a baking or firing process in a kiln, after which it is no longer typically said to be “green”. The methods and apparatus that we describe for transferring a pattern onto a substrate can be used, for example, to transfer a pattern onto green tiles, or onto tiles that have previously been fired one or more times. In some examples, when a tile has been previously fired and is being decorated again, the tile is typically warm (either from a previous process step or intentionally reheated) so that materials (for example jetted materials) applied to the tile will dry.

Ceramic tile decoration 37, in this example, includes one or more steps of glazing, printing, or using brushes (or combinations of them) to create grooves, patterns, images, text, or texture in the tiles 19, among other things.

As one step in the process of tile decoration, at a frit glaze station 25, frit, which are small glass particles, are flood coated (deposited) on tiles 19. The frit particles are fired into a frit glaze in a kiln 20. The frit glaze seals the tiles 19 and creates a glossy finish on the tiles to form substrate units 22 that can accept printing of a pattern and other decorative effects. Also as part of the decoration process, inkjet printing is done at an inkjet printing system 28 that includes one or more inkjet printing (pigment transfer) stations 14.

As shown in FIG. 2A, in some examples of a digital printing station 14, a material 200 (e.g., a phase change material) is jetted from orifices 198 of inkjets 195 of one or more inkjet heads 18 that are part of an ink jet printer 29. The material 200 is jetted onto an exposed surface 199 of a resilient closed-loop belt 201 (or a drum 290 as shown in FIG. 2E) in a pattern 202 (i.e., a desired pattern that is to appear on the substrate unit 22).

The belt 201 wraps around (and is driven by a motor 220 on at least one of) two relatively small diameter (e.g., a diameter in the range of 1 to 4 inches) pulleys 209 that are arranged vertically one above the other in this implementation. The material 200 could be tacky as it leaves the orifices of the inkjets, or it could be more liquid as it leaves the orifices and becomes tacky after it is laid down, for example, as its temperature decreases. For example, the material 200 could include a wax base that is maintained in a warm liquid state in the inkjet system, is liquid when it is jetted, quickly cools once applied to the surface of the belt, and, as it cools, becomes tacky before it freezes.

As shown in FIG. 2F, a graph depicting a change in state of the material 200 as a function of its temperature, the material 200 is kept at a temperature T₁ in the inkjet head 18. At this temperature, the material 200 is in a warm liquid state and remains in the liquid state when jetted. After the material 200 is jetted onto belt 201, the material 200 rapidly cools to Tₜ. At this temperature, the material 200 is tacky. The material 200 can be further cooled to and below the temperature Tₒ, at which point the material 200 freezes and is no longer tacky.

More generally, the jetted material can be UV cured instead of cooled.

As illustrated in FIG. 2C, a top view of a segment of the belt 201 at a lay-down location 203, the tacky material 300 (we sometimes refer to the phase change material in its tacky state as the tacky material 300) has been provided in a pattern 202, particles of dry ceramic pigment 203 that will produce desired printed effects, once fired, can be uniformly applied to the regions 206 of the belt 201 that have the patterns 202. Only a portion 209 of the dry particles of the ceramic pigment 203 that come into contact with the tacky material 300 laid in the jetted pattern 202 are retained (but are not retained in non-pattern, non-tacky regions 197). In other words, a portion 215 of loose particles of the ceramic pigment 203 that have been deposited beyond a boundary 206 (shown in FIG. 2C) of the pattern 202 are not retained by the tacky material 300 and can fall (by gravity) or otherwise removed from the belt 201 to a collection trough 207 and be re-used or discarded.

A roller 208 (FIG. 2A) can be used to mechanically apply pressure on the portion 204 of retained particles of the ceramic pigment 203 to embed the particles of the pigment more securely in the tacky material 300 just after the dry particles of the pigment are applied and before the pattern is transferred to the substrate units 22.

A series of copies of a single pattern, or a series of different patterns (with the possibility that each pattern in the series is unique) 211, 213, 215, 217 are laid down at successive locations along the belt as the belt is moved around the two pulleys. The spacing 219 between each pair of successive patterns laid down on the belt is carefully controlled to match the spacing 221 between each corresponding pair of successive units 22 of substrate. The position of each pattern on the belt is also carefully controlled so that registration with other related patterns that will be laid down by other inkjet printing stations in the system is accurate.

As the belt is moved, each pattern, in turn, reaches the upper surface 229 of the corresponding substrate unit 22. At that point, which in this example is at the lowermost position 230 of the belt, the dry particles of the ceramic pigments 203, which are embedded at the surface of the tacky material on the belt are put into (or nearly into) contact with the upper surface 231 of the substrate unit 22.

As the belt continues to move, a conveyor 232 (which can be part of the conveyor 15 shown in FIG. 1), on which the successive substrate units are carried, is also moved in a direction 233 in synchronization with the belt. As the belt and the relevant substrate unit move together in the example shown in FIG. 2A, the pattern of pigment is transferred to the substrate unit.

Transfer of the pigment pattern of the substrate unit could be achieved in a variety of ways. In the example shown in FIG. 2A, the transfer is achieved by warming the tacky material to make it more fluid to allow the associated pigment pattern to relocate onto the surface of the substrate unit 22 while maintaining an appropriate viscosity to retain the jetted pattern intact and the embedded particles of pigment in the intended locations. Care must be taken not to overheat the tacky material such that it becomes too fluid, which could cause the previously jetted pattern to degrade.

As shown in FIG. 2D, in some implementations, it is the heat from substrate units 22 that causes the pattern 202 of tacky material 300 to melt and be released from the belt 201. In an intermediate state before the pattern 202 fully detaches from belt 201, a portion of the tacky material 300 remains attached to the belt so that the segment of the tacky material that supports the pattern bridges between the hot substrate unit 22 and the belt 201. The heat needed to warm the tacky material could come from a range of sources. In the implementation shown in FIG. 2A, the substrate unit can be a hot green tile at about 100° C. that has passed through the drying oven 17 (FIG. 1). In other types of printing, hot green tiles from the drying oven 17 are typically actively cooled down before printing. Directly printing on hot green tiles that have passed through the drying oven 17 helps to conserve energy as hot green tiles do not need to be actively cooled down and also do not need to be separately heated to cause the tacky material to be released from the belt 201 and be deposited onto the hot green tiles. The heat from the hot green tiles makes the tacky material 300 molten, releasing it from the belt 201 together with the entrained particle of the ceramic pigment 203.

The belt 201 can be spaced apart from the substrate unit 22 by a gap 238 that is greater than the combined thickness 240 of the tacky material and the embedded particles. In that configuration, heat 242 rising from the hot substrate units causes the melting of the tacky material and gravity allows the particle pattern to fall onto the surface of the substrate. In some implementations, the belt could be close enough to the surface of the substrate to cause contact of the embedded particles with the surface of the substrate before the melting of the tacky material.

After the pattern 202 containing the ceramic pigment 203 is transferred onto substrate units 22 and (if intended) related patterns of other ceramic pigments are transferred onto the surface of the substrate units 22 at other printing stations to complete a multicolor pattern, the substrate units 22 will be fired in a kiln 21 (FIG. 1) (possibly with other processing steps occurring prior to the firing). The kiln causes the tacky material 202 to be removed from the patterned tile by causing it to evaporate or to burn or a combination of the two, leaving the two-dimensional multicolor pattern to be fired to form a permanent pattern on the surface of the tile. In this way, a two-dimensional pattern 15 is produced on an exposed upper surface 16 of each of the substrate units 22.

In general, ceramic pigment 203 having any size and shape of particles can be used. In any given pigment, the particles can have a range of sizes and the distribution of sizes to achieve desired colors and effects in the permanent pattern. For those purposes, the particles may also have a uniform shape or a range of different shapes and a distribution of shapes. For example, ceramic pigment having large particles (larger than 8 microns) or small particles (smaller than 1 micron) can be used.

After the desired pattern bearing particles of the ceramic pigment is transferred onto the substrate units 22, the substrate units 22 may go through a second glazing station 27 where additional frit may be flood coated or deposited on the substrate units 22, in some cases selectively. Such a glaze adds depth to the color printed on the substrate units 22 earlier in the processing line. In addition, various types of brushes can be optionally used to create textures and designs on the substrate units 22.

FIG. 3 shows a flow chart of the steps involved in depositing a pigment pattern on a ceramic substrate. In step 301, a pattern 202 of a phase-change material 200 is deposited on an exposed surface of a transfer layer, such as a resilient closed-loop belt 201. The material 200 is allowed to cool to become a tacky material. Dry particles of a ceramic pigment 203 are deposited uniformly (or in some cases and for some purposes, non-uniformly) in regions 205 of the transfer layer that include both the pattern 202 and non-pattern portions 197 in step 302. Dry particles of the ceramic pigment 203 deposited in regions containing the pattern 202 of the tacky material 300 are retained to form a pattern of the dry particles of ceramic pigments. Dry particles of the ceramic pigment 203 deposited beyond a boundary 206 of the pattern 202 are not retained by the tacky material. Thereafter, in step 303, the pattern of dry particles is transferred onto an upper surface 229 of the substrate unit 22. Steps 301 to 303 can be repeated to deposit different patterns for retaining dry particles of different ceramic pigments on the ceramic substrate. When all the desired patterns have been transferred onto the ceramic substrate, the dry particles are fired to form a permanent pattern of a color or other printed effect on the ceramic substrate in step 304.

In order to form a final multi-colored pattern having a relatively high resolution on the substrate (e.g., ceramic tiles), multiple belts of multiple printing stations can be arranged in close proximity along the processing line to overlay multiple single-color patterns in close registration with one another.

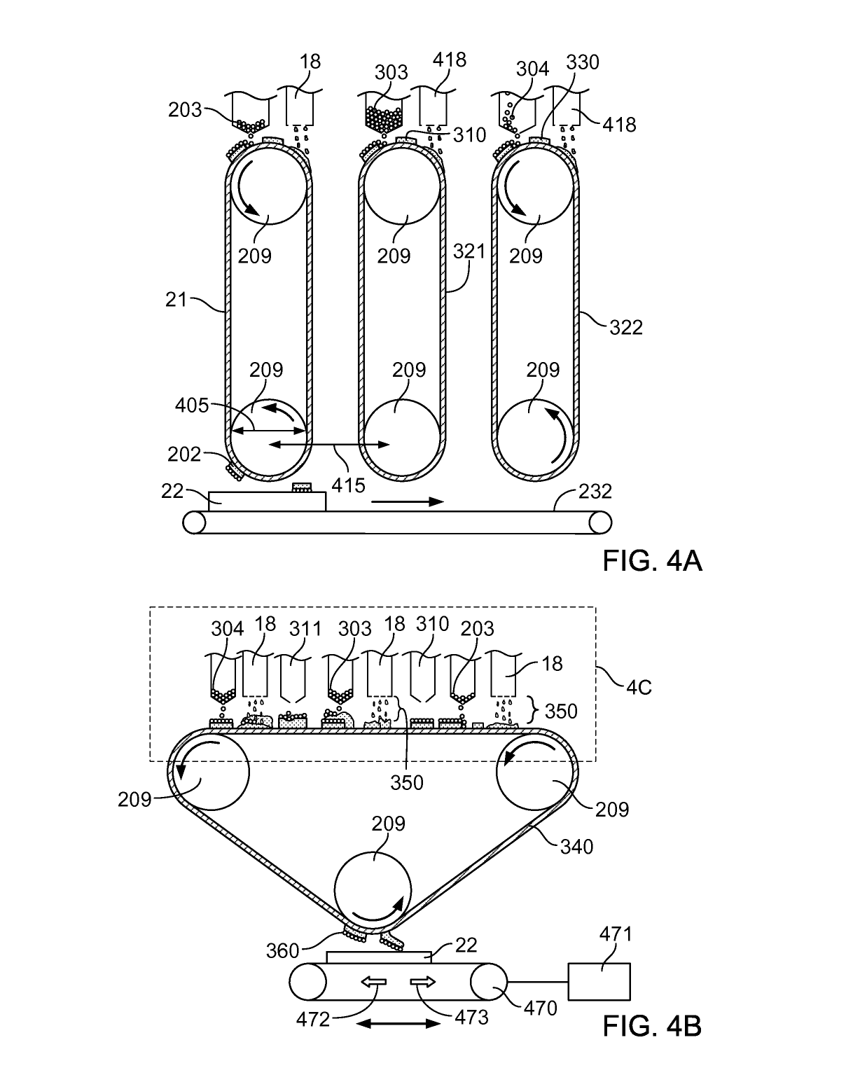

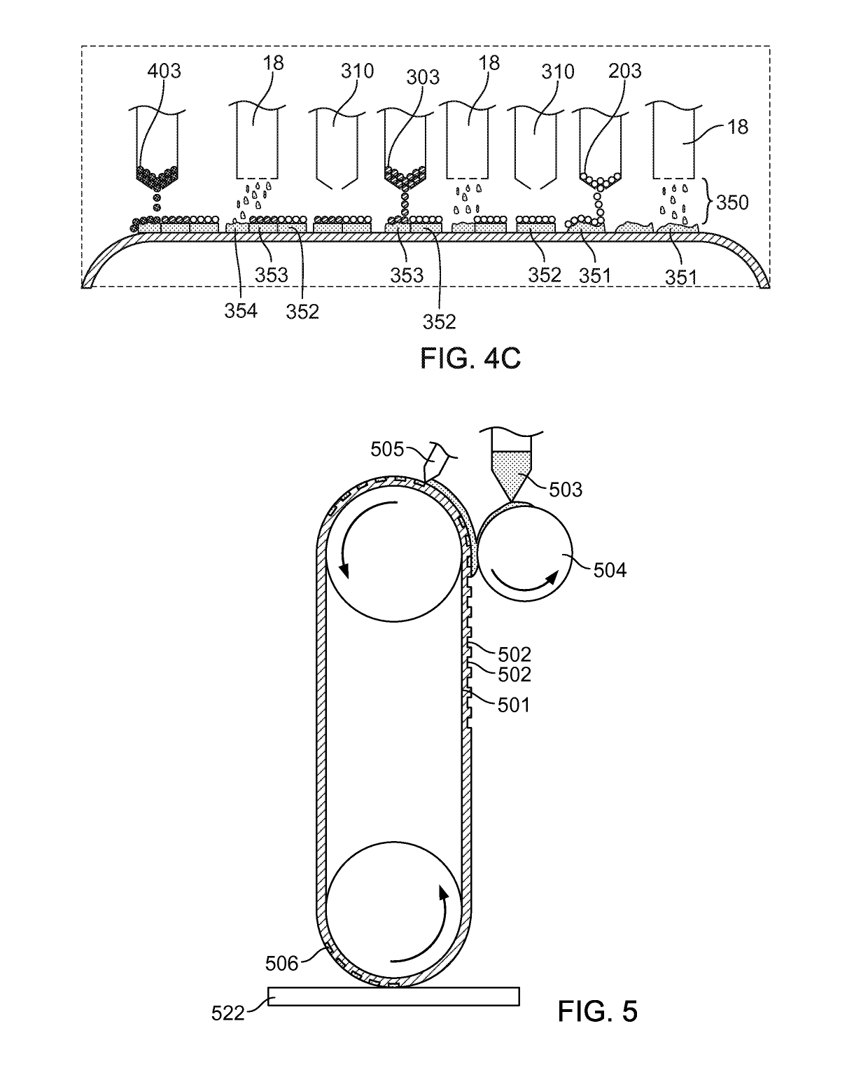

FIG. 4A shows belts 201, 321 and 322, each wrapped around two small diameter pulleys 209 each having a diameter 405, the two pulleys for each belt being positioned vertically above one another. The small diameter of pulleys 209 permits adjacent belts to be placed at a distance 415 from one another that is comparable to the diameter 405, for accurate registration between patterns of different colors.

The belt 201 receives particles of ceramic pigment 203 to provide a first color (or other printed effect) after tacky material 300 is deposited in the desired pattern 429 on the exposed surface of the belt. A hot substrate unit 22 is moved by the conveyor 232 to a position under the belt 201. Heat 242 from the substrate unit 22 causes the melting of the tacky material 300 and releases the its entrained particles of the ceramic pigment from belt 201. Gravity allows the particle pattern to fall onto the surface of the substrate unit 22.

In some implementations, each belt could be close enough to the surface of the substrate to cause contact of the entrained particles with the surface of the substrate before the melting of the tacky material. The substrate unit 22 is then transported by conveyor 232 to a position (e.g., the lowermost portion) under the belt 321. Arranged above the upper pulley and above belt 321 is another inkjet head 418 that jets material 200 in a pattern 310 on the exposed surface 399 of belt 321. The pattern 310 is the desired pattern for another color (or other printed effect) to be deposited on substrate unit 22. Particles of ceramic pigments 303 for this printed effect are applied uniformly to a region 450 of the exposed surface 399 of the belt 321 that includes the region containing the pattern 310 and non-pattern regions. Only particles deposited in the region containing the pattern 310 are retained. The pattern 310 is transported along the belt 321 to a position under the lower pulley, and placed in close contact with the substrate unit 22. In a similar fashion, heat from the hot substrate unit 22 causes the pattern 310 to detach from the belt 321 and be deposited on the hot substrate unit 22. The pattern 310 can be at least partially overlaid above the previously deposited pattern 429.

The same process is repeated to provide a pattern for a third (or further) color (or other printed effect) to the substrate unit 22. The hot substrate unit 22 on which the patterns 429 and 310 are deposited is transported to a position under the belt 322 by a conveyor 232. Above the belt 322 is a third inkjet head 419 that jets another pattern 320 of material 200. The pattern 320 is the desired pattern for a third color (or other printed effect) to be deposited on substrate unit 22. Particles of ceramic pigment 403 for the third color (or other printed effect) are applied uniformly to a region on the exposed surface of the belt 322 that includes the region containing the pattern 330 and non-pattern regions on the belt 322. Only particles deposited in the region containing the pattern 330 are retained. The pattern 330 is transported along the belt 322 to a position under the lower pulley, and placed in close contact with the substrate unit 22. In a similar fashion, heat from the hot substrate unit 22 causes the pattern 330 to detach from the belt 322 and be deposited on the hot substrate unit 22.

FIG. 4B shows an embodiment in which a single belt 340 is used to deposit a multi-color pattern 360 on hot substrate unit 22. FIG. 4C is a magnified view of the upper portion of FIG. 4B. Using a medium 200 that is only tacky above a particular temperature Tₒ and not tacky when frozen (i.e. at a temperature at or below Tₒ), a first pattern 351 of the medium 200 can be jetted before particles of pigment 203 for a first color (or other printed effect) is deposited uniformly on a region that contains both the pattern 351 and non-pattern regions. The jetted pattern 351 is transported along the belt 340 to a position under cooling device 310 which cools the medium 350 in the jetted pattern 351 below Tₒ and causes the medium 350 to change into a frozen pattern 352. The frozen pattern 352 entrains previously deposited particles of pigment 203 but not particles of pigments deposited on it after the pattern 352 has frozen. The frozen pattern 352 is transported to a position under a second inkjet head 468, and a second pattern 353 of medium 200 is jetted. Thereafter, particles of pigments 303 of a second color are deposited in a region that contains one or more of: the second pattern 353, the frozen pattern 352 and non-pattern regions. As the frozen pattern 352 is unable to retain particles of pigments 303 of the second color, particles of pigments 303 are only retained in region containing the second pattern 353. The processes may be repeated by adding particles of pigment 403 for a third color (or other printed effect) in a third pattern 355 after freezing the second pattern 353 into the second frozen pattern 354. The frozen patterns 352 and 354 and the last jetted pattern 355 are then moved by the belt to a location below the lowermost pulley.

A conveyor 470 transporting the substrate unit 22 can be operated bidirectionally as shown by the arrows 472 and 473. The substrate may be moved in the direction 473 while the first frozen pattern 352 is released from belt 340 by the heat emanating from the substrate unit 22. The counterclockwise movement of the belt 340 together with the movement of the substrate in the direction 473 allows the first frozen pattern 352 released from the belt 340 to be deposited on the substrate unit 22. When the second frozen pattern 354 is to be overlaid above the first frozen pattern 352, the substrate unit 22 is driven in a reverse direction 472 to position the substrate unit 22 at the appropriate location to receive the second frozen pattern 354 when it is heated and released from the belt 340. The belt 340 continues in its counterclockwise movement during the bidirectional movement of the substrate unit 22. An electronic processor 471 controls the movement of conveyor 470. Thus, a multicolor image can be created on the substrate unit 22. For example, in some embodiments, a vacuum system can be used to remove excess pigment after every deposition of color pigments on the belt 340.

An analog system may also be included in the processing line 12. In an analog printing station shown in FIG. 5, a silicone rotogravure belt 501 is used to print a pattern having a particular color on a tile. The pattern to be printed is imparted using the silicone belt 501 patterned with recesses 502 or holes. An ink 503 is spread over the belt 501 using a roller 504, a squeegee 505 is used to wipe away the excess ink on the surface of belt 501 so that ink is only present in the recesses of the silicone belt 501. The ink 506 in the recesses is then transferred from the drum to the tile 522.

The system that we have described can deliver relatively a high-resolution multicolor pattern of both small particle and large particle pigments digitally onto tiles moving down a processing line. Among a wide variety of other possibilities, the pattern that is laid down can be a pattern to achieve any possible printed effect, including one or more colors and represent decorations, text, images, or graphics, among other things.

In embodiments shown in FIG. 4B where operation is continuously in one direction, the entire multi-color pattern is laid down on the transfer belt 340 and all colors transferred at once to the substrate unit 22.

Other implementations are also within the following claims.

1. A method comprising:
providing a pattern of dry particles of a pigment on a tacky surface on a transfer layer, and
transferring the pattern of the dry particles onto a surface of a ceramic substrate in preparation for firing the dry particles to form a permanent pattern on the ceramic substrate.

2. The method of claim 1 in which the providing of a pattern of dry particles of a pigment on a tacky surface comprises forming a pattern of tacky material on the surface.

3. The method of claim 2 in which forming a pattern of tacky material on the surface comprises jetting a material.

4. The method of claim 1 in which the providing of a pattern of dry particles of a pigment on a tacky surface comprises applying dry particles of the pigment to a pattern of tacky material on the surface.

5. The method of claim 1 in which the transferring of the pattern of the dry particles onto the surface of the ceramic substrate comprises bringing the pattern into close proximity to or in contact with the ceramic substrate.

6. The method of claim 5 in which the ceramic substrate has a temperature above the ambient temperature when the pattern is in close proximity to or in contact with the ceramic substrate.

7. The method of claim 6 in which the ceramic substrate is at a temperature between 80° C. and 120° C.

8. The method of claim 1 comprising providing a second pattern of dry particles of a second pigment on a tacky material on the transfer layer.

9. The method of claim 8 comprising freezing the pattern of dry particles before providing the second pattern of dry particles of a second pigment.

10. The method of claim 1 comprising coordinating a movement of the ceramic substrate to a movement of the transfer layer to achieve registration.

11. The method of claim 9 comprising coordinating a movement of the ceramic substrate to the movement of the transfer to achieve registration of the pattern and the second pattern on the substrate.

12. The method of claim 1 in which the pattern comprises multiple identical patterns on the transfer layer.

13. The method of claim 12 in which a spacing between the multiple identical patterns on the transfer layer is controlled to match a spacing between a plurality of ceramic substrates onto which the identical patterns are to be transferred.

14. The method of claim 1 in which the pattern comprises multiple unique patterns on the transfer layer.

15. The method of claim 14 in which a spacing between multiple unique patterns on the transfer layer is controlled to match a spacing between a plurality of ceramic substrates onto which the multiple unique patterns are to be transferred.

16. The method of claim 1 in which the transferring of the pattern of dry particles comprises heating the pattern of dry particles to release the pattern from the transfer layer.

17. The method of claim 2 in which the tacky material comprises wax.

18. The method of claim 16 in which the ceramic substrate is not heated during the transferring of the pattern.

19. The method of claim 1 further comprising providing a pattern of dry particles of a second pigment on a tacky surface on a second transfer layer.

20. The method of claim 19 in which the transfer layer and the second transfer layer are separated by a distance along the width of the transfer layer on the order of the width of the transfer layer.

21. The method of claim 1 in which the dry particles have a diameter of between 8 and 20 microns.

22. The method of claim 1, in which the dry particles have a diameter of between 5 and 8 microns.

23. The method of claim 1, in which the dry particles have a diameter of between 0.5 to 5 microns.

24. A method comprising:
providing a pattern of dry particles of a pigment on a tacky surface on a transfer layer, and
transferring the pattern of the dry particles onto a surface of a rigid substrate in preparation for processing the dry particles to form a permanent pattern on the rigid substrate.

25. The method of claim 24, in which the rigid substrate comprises at least one of stone tiles, slate tiles, metal tiles and ceramic tiles.

26. The method of claim 24 in which the tacky surface comprises a jetted material.

27. The method of claim 24 in which the providing of a pattern of dry particles of a pigment on a tacky surface comprises applying dry particles of the pigment to a pattern of tacky material on the surface.

28. The method of claim 24 in which the transferring of the pattern of the dry particles onto the surface of the rigid substrate comprises bringing the pattern into close proximity to or in contact with the rigid substrate.

29. The method of claim 24 comprising coordinating a movement of the rigid substrate to a movement of the transfer layer to achieve registration.

30. The method of claim 24 in which the transferring of the pattern of dry particles comprises heating the pattern of dry particles to release the pattern from the transfer layer.

31. The method of claim 24 further comprising providing a pattern of dry particles of a second pigment on a tacky surface on a second transfer layer.

32. The method of claim 31 in which the transfer layer and the second transfer layer are separated by a distance along the width of the transfer layer on the order of the width of the transfer layer.

33. A transfer apparatus, comprising:
a first surface to temporarily hold a pattern of dry particles of pigments,
a second surface to support a substrate onto which the pattern of dry particles of pigment is to be transferred; and
a conveyor to move the first surface relative to the second surface to cause the pattern of dry particles of pigments to be transferred onto the substrate.

34. The transfer apparatus of claim 33, in which the conveyor coordinates a movement of the second surface to a movement of the first surface to achieve registration.

35. The transfer apparatus of claim 33, further comprising a heater to heat the pattern of dry particles to release the pattern from the first surface.

36. The transfer apparatus of claim 33, further comprising a third surface to hold a pattern of dry particles of a second pigment.

37. The transfer apparatus of claim 36, in which the first surface and the third surface are separated by a distance along the width of the first surface on the order of the width of the first surface.

38. A printing system, comprising:
the transfer apparatus of claim 33;
an inkjet head to jet a pattern of tacky material onto the first surface;
an applicator of dry particles of pigments to deposit the dry particles onto the pattern of the tacky material to form a pattern of dry particles of pigments corresponding to the pattern of tacky material;
a kiln to fire the pattern of dry particles of pigments permanently onto the substrate; and
a conveyor to move the substrate bearing the dry particles of pigments to the kiln for firing.

39. A processing line comprising:
the printing system of claim 38, in which:
the substrate comprises hot green tiles, and
the printing system is to receive the plurality of hot green tiles on the second surface.

40. An article, comprising:
a ceramic substrate bearing a jetted pattern comprising at least one of: wax, glue, epoxy, and adhesive, and
dry particles of pigments held by the jetted pattern.
